(19) United States
(12) Patent Application Publication
(10) Pub. No.: US 2009/0145969 A1
(43) Pub. Date: Jun. 11, 2009

(54) Promotional card and method of distributing same

(76) Inventor: Paul D. Daley, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/999,692

(22) Filed: Dec. 6, 2007

(51) Int. Cl. G06Q 30/00; G06K 19/06

(52) U.S. Cl. 235/491; 235/487; 235/492; 235/493; 705/14

(57) ABSTRACT

An embodiment of the present promotional card has a surface area. A first section of the surface area identifies a promotional target. A second section of the surface area includes identifying indicia for associating the promotional card with a preexisting stored value account. An embodiment of the present promotional card may be used in the promotion of an idea to a target. The target is provided with a promotional card intended to form a positive association with the idea and also to provide the target with a benefit. The benefit is obtainable through use of the promotional card. The target's positive association with the idea is reinforced when the target receives the promotional card and learns of the benefit and further reinforced when the benefit is obtained.

### CROSS-REFERENCE TO RELATED APPLICATIONS

None

### BACKGROUND OF THE INVENTION

The use and function of business cards is well understood. A business card is often a rectangular piece of cardstock having front and back panels, at least one of the panels being marked with information about the giver of the card. Such information typically includes the giver's name, position within or affiliation with a particular business or organization, a logo, and contact information, such as a telephone number, street address, e-mail address, and/or website. Graphics may be added to make the card more distinctive and visually appealing to the recipient. Likewise, other materials may be used, such as plastic or metal, in order to make a particular business card more distinctive. Such business cards are sized to be easily carried and stored by the recipient, such as in a wallet or other container. In the United States, business card dimensions are commonly 89 mm by 51 mm (3.5″×2″). Other common sizes are 91 mm by 55 mm (Japan), 85 mm by 55 mm (Europe), and 90 mm by 55 mm (Australia).

Separately, the use and function of stored value cards is also well understood. It has been known to provide a form of stored value card as a gift card. Such stored value cards are issued by merchants and are activated upon purchase by a customer. An activated stored value card represents an amount of money, typically the purchase price of the card, on deposit in an account with the issuing merchant; in this respect the stored value card is similar to a conventional debit card issued by a bank. Each gift card is typically marked with a retailer identification on the front panel of the card and a means for associating the individual card with a unique account on the back panel of the card. Exemplary means for associating a card with an account are magnetic strips, bar codes, human readable serial numbers, radio frequency identification (RFID) tags, or the like. The card may then be used as payment to the issuing merchant for goods or services. Upon presentation of the card at the point of sale, the amount owed for the goods or services is deducted from the account associated with the stored value card.

For example, assume a retail merchant makes gift cards available for purchase at a checkout register. A customer selects an individual gift card and an amount, for instance $50. The customer then “purchases” the gift card for the selected amount and the merchant records the gift card's account number and the selected value, $50. In effect, the customer has made a $50 deposit with the merchant. The customer may then keep the card for his own use or transfer ownership of the card to another. Whoever is in possession of the card (the cardholder) may return to the merchant and use the card as payment of goods or services.

There are three general categories of stored value cards. Closed system stored value cards are associated with an individual merchant and are redeemable only with that merchant. Semi-closed system stored value cards on the other hand are associated with a group of affiliated merchants, such as those within a particular geographic area or those owned by a common parent company. Open system purchasing stored value cards, also known as stored value credit cards, are generally associated with a large widely accepted credit card provider and may be redeemed at any merchant that accepts the provider's credit cards.

A business or other entity may use gift cards in conjunction with its own correspondence or marketing materials to increase the goodwill of actual or potential customers. For example, a new business trying to attract new customers may give potential customers promotional materials accompanied by a gift card for a popular restaurant. Similarly, a company experiencing a delay in its ability to provide a promised good or service to a customer may send a letter to the customer apologizing for the delay accompanied by a gift card to a local retailer. The intent of such gratuities is for the recipient to associate the pleasurable feeling created by receiving a gift with the giving business. However, the association formed by such gratuities may not last past the time it takes the recipient to separate the gift card from the accompanying materials. Thus, what is needed is a way to prolong the association between the enjoyment created by receiving a gift card and the goodwill towards the giver.

### SUMMARY OF THE INVENTION

An aspect of a promotional card according to the disclosure herein includes a promotional card having a surface area. A first section of the surface area identifies a promotional target and a second section of the surface area includes identifying indicia for associating the promotional card with a preexisting stored value account.

According to another aspect of a promotional card according to the disclosure herein includes a promotional card associated with a stored value account and having a surface area. The promotional card has a first section of said surface area that identifies a promotional target. The promotional card also has a second section of said surface that includes indicia for identifying the stored value account. The stored value account stores a value which represents funds held by an account provider. The funds may be used by a holder of said promotional card, subject to restrictions defined by said account provider.

An aspect of a method of promoting an idea to a target according to the disclosure herein includes providing the target with a promotional item intended to form a positive association with the idea and also providing the target with a benefit. The benefit is obtainable through use of the promotional item. The target's positive association with the idea is reinforced when receiving said promotional item and when obtaining said benefit.

An aspect of a method of providing marketing services to an entity according to the disclosure herein includes forming an arrangement with at least one supplier to supply a benefit, causing a promotional item for the entity to be created, and providing said entity with said promotional item. The item includes a message intended to identify and promote the entity to another. The item also includes a message identifying the supplier and the benefit. The item is redeemable with the supplier for the benefit. The entity may thereafter provide another with the promotional item.

An alternative aspect of a method of providing marketing services to an entity according to the disclosure herein includes forming an arrangement with at least one supplier to supply a benefit; causing a promotional item to be created, and providing the entity with the promotional item, enabling said entity to thereafter provide another with said promotional item. The promotional item includes a message intended to identify and promote the entity to another and also includes a message identifying the supplier and the benefit. The promotional item is redeemable with the supplier for the benefit.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1A is a front view of an embodiment of the promotional card disclosed herein.

FIG. 1B is a rear view of the embodiment shown in FIG. 1A.

FIG. 2 is a front view of an alternative embodiment of the promotional card disclosed herein.

FIG. 3 is a rear view of an alternative embodiment of the promotional card disclosed herein.

### DETAILED DESCRIPTION OF PREFERRED EMBODIMENTS

A preferred embodiment of the present promotional card is a piece of a substantially rigid material, such as thermoplastic polymers polyvinyl chloride (PVC) or acrylonitrile butadiene styrene (ABS). An alternative embodiment of the present promotional card is a section of card stock, preferably having a weight of at least 400 g/m². The physical characteristics of an embodiment, such as size, weight, and materials, may be similar to those of a credit card or a business card. The promotional card includes a front panel and an opposite back panel. The front and back panels make up the useable surface area of the promotional card. The usable surface area is divided into at least two sections, a promoting section and a gratuity section. A stored value account is associated with the promotional card. In use, a giver may give a promotional card to a recipient and the recipient, or any other bearer of the card, may redeem the associated stored value.

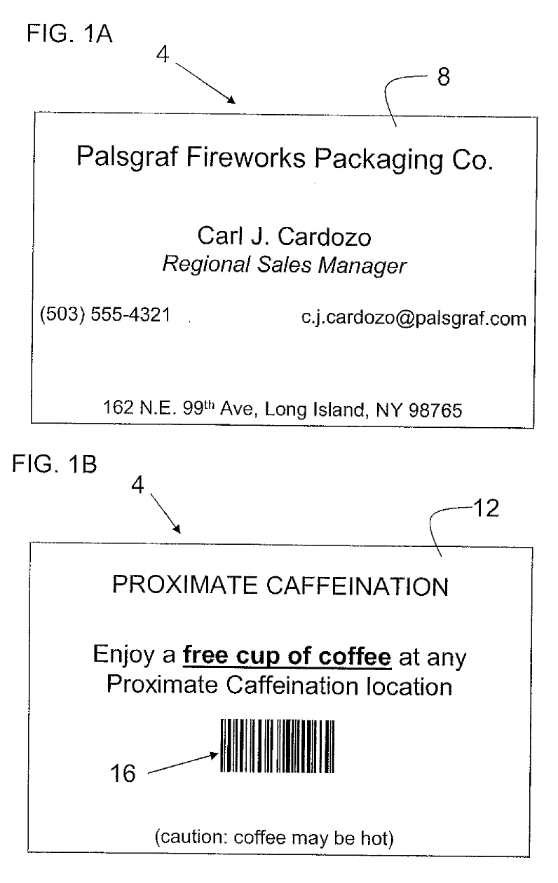

FIGS. 1A and 1B illustrate an embodiment of the present promotional card 4. The illustrated embodiment is of similar dimensions as a conventional credit card, debit card or the like. Promotional card 4 has a front panel 8 (FIG. 1A) and an opposite, rear panel 12 (FIG. 1B). The promotional section occupies front panel 8 and the gratuity section occupies rear panel 12. The promotional section identifies a promotional target and may include, but is not limited to, the target's name, position within or affiliation with a particular business or organization, a logo of a business or organization, and/or contact information, such as a telephone number, street address, e-mail address, and/or website. In the illustrated embodiment, the promotional section contains an image of a business card. The gratuity section may contain markings similar to those found on a gift card, such an identification of one or more merchants, human and/or machine readable indicia for uniquely identifying the individual promotional card and an associated stored value account (hereafter referred to as a promotional card's “identifying indicia”), and other markings, such as a trademark or promotional message. The identifying indicia may be a human readable serial number, a bar code, a magnetic strip, an RFID tag, an integrated circuit, or the like. In the embodiment shown in FIG. 1B, the identifying indicia is a bar code 16.

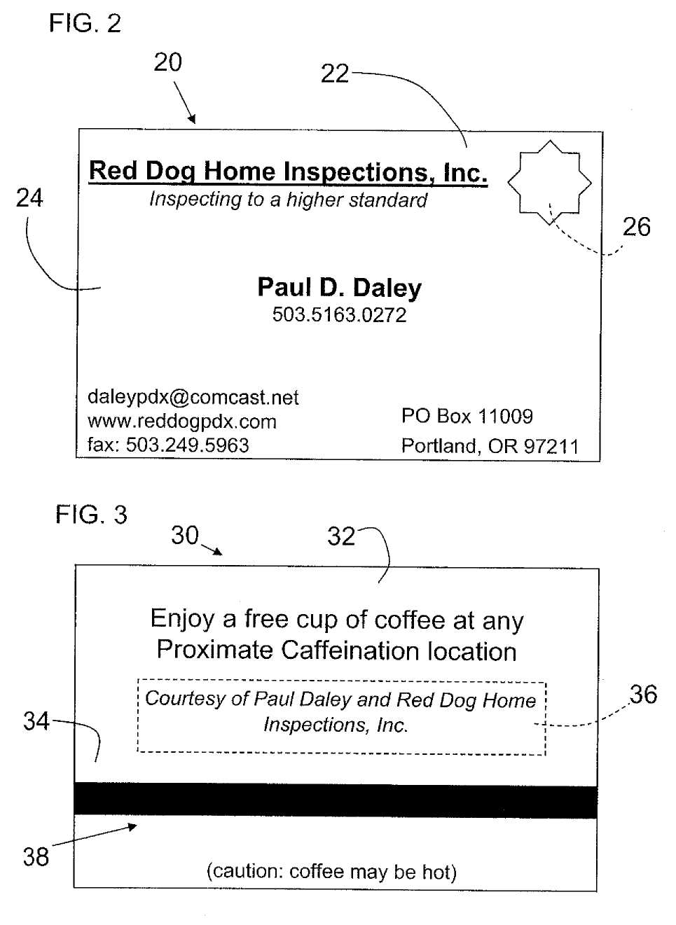

FIG. 2 and FIG. 3 illustrate alternative embodiments of the present promotional card 20, 30. Referring to FIG. 2, front panel 22 contains promotional section 24 and secondary gratuity section 26 (indicated by dashed line). The rear panel (not shown) may be similar to either of the rear panels shown in FIG. 1B or FIG. 3. The secondary gratuity section may include a logo, trademark, or other promotional or identifying markings. Referring to FIG. 3, rear panel 32 contains gratuity section 34 and secondary promotional section 36 (indicated by a dashed line). The front panel (not shown) may be similar to either of the front panels shown in FIG. 1A or FIG. 2. The promotional card's identifying indicia is shown as a magnetic strip 38. The embodiments shown in FIGS. 2 and 3 allow a bearer of respective promotional card 20, to identify the existence of the gratuity or the identity of the promotional target by viewing only the illustrated panel 22; 32. Additionally, both secondary sections 26, 36 may serve to reinforce and prolong the recipient's association between the pleasure caused by the gratuity and the identity of the giver.

The markings illustrated on both the front and rear panels in the above embodiments are intended to be merely illustrative and in no way reflect limitations on the scope of markings that may be placed on an embodiment of the present promotional card, other than those limitations defined by the claims which follow this detailed description. For example, the secondary gratuity section 26 (FIG. 2) may be placed anywhere on the front panel 22. Similarly the secondary promotional section 36 (FIG. 3) may be placed anywhere on the rear panel 32.

In an exemplary distribution model for promotional cards, including those described above, embodiments of the present promotional card are ordered by a giver from a custom promotional card supplier. The giver contacts the supplier and arranges for the production of custom promotional cards bearing a promotional image, such as the image of the giver's business card. The supplier may allow the giver to select one or more merchants to associate with the giver's custom promotional cards and the value of the gratuity provided with each card (e.g. $5.00 or the price of a particular product). The supplier then produces the desired number of promotional cards and arranges to fund the stored value accounts necessary to redeem the associated gratuities. The supplier then provides the custom promotional cards to the giver, who may then distribute the custom promotional cards as desired. The recipients of the custom promotional cards then patronize the merchant identified in the gratuity section in order to redeem the gratuity, increasing and reinforcing the recipient's goodwill towards the giver. While redeeming the gratuity, the recipients may also make additional purchases from the merchant thus conferring an added benefit to the merchant.

The supplier may advantageously have preexisting arrangements with one or more merchants to supply promotional cards whose gratuity is redeemable with the merchants. For example, the supplier may have previously reserved access to a block of each merchant's stored value account numbers to associate with promotional cards to be produced in the future. Alternatively, the supplier may wait until a giver requests a gratuity from a particular merchant before the supplier arranges for the necessary stored value account. Alternatively, the supplier may exclusively provide custom promotional cards associated with a particular merchant.

In the preferred embodiments of the present promotional card, from the perspective of the recipient the promotional target identified in the promotional section is preferably distinct from the merchant from whom the gratuity identified in the gratuity section may be redeemed.

As described above, the stored value accounts associated with embodiments of the present promotional card are pre-funded with a set amount of purchasing power, representing the value of the gratuity. Advantageously, the level of purchasing power may be increased upon the request of either the giver or the recipient. For example, if a giver wishes to remind a prior recipient of a promotional card of a prior relationship between the giver and the recipient, the giver may arrange additional funding to be deposited with the stored value account associated with the recipient's promotional card. The giver may then selectively notify the recipient of the deposit. Similarly, a giver may increase the funding in a prior recipient's stored value account as a reward, for example for bringing the giver repeat business, for participating in an especially beneficial transaction, or for referring the giver to others. In addition to the goodwill created by the deposit, the recipient's knowledge of the mere potential for an additional gratuity increases the likelihood the recipient will keep the giver's promotional card after having redeemed the original gratuity.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow. As non-exclusive examples: the form the markings on a particular instantiation of an embodiment of the present promotional card will vary according to the purpose of the instant card; the stored value account may be associated with a closed, semi-closed, or open purchasing system; the gratuity may be redeemable from one or more merchants, at a physical retail establishment, over the telephone, on the internet, or any combination thereof; and the entity providing the cards to recipients may be the promotional target identified in the card's promotional section or a third party promotional or marketing firm.

What is claimed is:

1. A promotional card having a surface area and comprising:
(a) a first section of said surface area identifying a promotional target; and
(b) a second section of said surface area including identifying indicia for associating said promotional card with a stored value account.

2. The promotional card of claim 1, wherein said second section further comprises at least one marking for identifying at least one merchant associated with said stored value account.

3. The promotional card of claim 2, wherein said promotional target is an entity other than said merchant.

4. The promotional card of claim 1, wherein said surface area is defined by a first panel and an opposite second panel, said first section substantially takes up said first panel, and said second section substantially takes up said second panel.

5. The promotional card of claim 1, wherein said first section comprises an image of a business card identifying said promotional target.

6. The promotional card of claim 1, wherein said first section comprises contact information for said promotional target.

7. The promotional card of claim 1, wherein said identifying indicia comprises a magnetic strip with machine readable information pertaining to said stored value account stored therein.

8. The promotional card of claim 1, wherein said identifying indicia comprises a bar code with machine readable information pertaining to said stored value account stored therein.

9. The promotional card of claim 1, further comprising a radio frequency identification tag with machine readable information pertaining to said stored value account stored therein.

10. The promotional card of claim 1, further comprising an integrated circuit having an output contact point on said surface area and with machine readable information pertaining to said stored value account stored therein.

11. The promotional card of claim 1, wherein said identifying indicia comprises a serial number associated with said stored value account.

12. The promotional card of claim 1, wherein said surface area is defined by a first panel and an opposite second panel, said first section partially takes up said first panel, and said second section takes up the remainder of said first panel and substantially takes up said second panel.

13. The promotional card of claim 1, wherein said surface area is defined by a first panel and an opposite second panel, said first section partially takes up said first panel, and said second section takes up the remainder of said first.

14. The promotional card of claim 1, further comprising an identification of a source of said promotional card, said source being an entity other than said promotional target.

15. A promotional card associated with a stored value account, said promotional card having a surface area and comprising:
(a) a first section of said surface area identifying a promotional target; and
(b) a second section of said surface including indicia for identifying said stored value account; and
wherein said stored value account stores a value, said value representing funds held by an account provider and useable by a holder of said promotional card, the use of said funds being subject to restrictions defined by said account provider.

16. The promotional card of claim 15, wherein said value stored in said stored value account can be increased.

17. The promotional card of claim 15, wherein said value stored in said stored value account is controllable by an entity other than said account provider and said holder.

18. A method of promoting an idea to a target comprising:
(a) providing said target with a promotional item, causing said target to form a positive association with said idea; and
(b) providing said target with a benefit, said benefit being obtainable through use of said promotional item;
whereby said target's positive association with said idea increases at least when learning of said benefit and when obtaining said benefit.

19. The method of claim 18, wherein said promotional item is provided by a provider capable of meeting a need of said target and said idea relates to using said provider to meet said need.

20. The method of claim 19, wherein said provider represents a commercial entity, said target is a potential customer of said entity, and said idea relates to said target patronizing said commercial entity.

21. The method of claim 19, wherein said benefit is obtained by said target from a third party and the method comprises, prior to step (a), said third party being compensated by said provider for said benefit; and said promotional item being marked with at least indicia identifying said provider, indicia identifying said third party, and indicia identifying said benefit.

22. The method of claim 18, wherein said promotional item takes the form of a promotional card having a stored value associated therewith.

23. The method of claim 18, further comprising informing said target of the possibility of a further benefit being provided in addition to the benefit provided in step (b) and being obtainable through the use of said promotional item, wherein said target's positive association with said idea increases at least when learning of the possibility of said further benefit being selectively provided.

24. The method of claim 23, further comprising selectively providing said target with said further benefit, wherein said target's positive association with said idea increases at least when learning of said further benefit being selectively provided, and when obtaining said further benefit.

25. A method of providing marketing services to an entity comprising:
(a) forming an arrangement with at least one supplier to supply a benefit;
(b) causing a promotional item for said entity to be created, said item including a message intended to identify and promote said entity to another, further including a message identifying said supplier and said benefit, and being redeemable with said supplier for said benefit; and
(c) providing said entity with said promotional item, enabling said entity to thereafter provide another with said promotional item.
